(19) United States
(12) Patent Application Publication
(10) Pub. No.: US 2006/0031158 A1
(43) Pub. Date: Feb. 9, 2006

(54) Credit card with incentives tied to credit score

(76) Inventor: Suze Orman, Hillsboro Beach, FL (US)

Correspondence Address: PILLSBURY WINTHROP SHAW PITTMAN LLP, 725 S. FIGUEROA STREET, SUITE 2800, LOS ANGELES, CA, 90017, US

(21) Appl. No.: 10/914,609

(22) Filed: Aug. 9, 2004

(51) Int. Cl. G06Q 40/00

(52) U.S. Cl. 705/38

(57) ABSTRACT

A credit product issuer markets a credit product to a targeted group of consumers offering incentives to the targeted group if the consumers improves their management of their financial affairs, e.g., reduces a credit score. A consumer receives an application for the credit card and submits the credit card application to the issuer. The credit card issuer accepts the application for the credit card from the consumer and establishes a consumer account and an initial interest rate. The initial interest rate is based on an initial credit score for the consumer and other consumer credit information. The credit card issuer activates the consumer account. The credit score of the consumer is automatically monitored on a periodic basis and the initial interest rate is adjusted to a new interest rate if the credit score of the consumer has changed.

### BACKGROUND OF THE INVENTION

For many consumers, personal debt continues to grow at a pace that is greater than the consumers' increase in personal income and ability to pay down the debt. Personal debt includes home mortgages, automobile loans, student loans, and credit card or debit card debt. While home mortgages and automobile loans are backed by homes and the autos, respectively, which lenders can foreclose on, credit card issuers have no such recourse against consumers who default on credit card or debit card debt.

In spite of this, credit card and debit card issuers continue to offer their products to consumers for whom their product offerings may not be appropriate because of existing debt or other employment or financial reasons. The credit card issuers continue to send out multiple credit card offerings to consumers attempting to entice the consumer to sign up for more and more credit card debt. This enticement includes offering the consumers low introductory interest rates for a startup period of time, or offering airline miles for each dollar charged on the credit card. By continuing with this type of business behavior, the credit card companies are providing the vehicles that are driving many consumers into deeper and deeper financial trouble.

Initially, the credit card issuer determines an interest rate for a consumer based on a number of factors. These factors are normally received by requesting a credit report from an independent third party, e.g., such as a credit bureau. One of these factors is a credit score, e.g., a FICO® score, which is an indicator of a consumer's creditworthiness. A Fair Isaac Corporation, Inc. (FICO®) score is a score which is calculated using information that is contained in any of the three national credit bureau specifically for the purpose of allowing a lender to assess the default risk of a credit applicant. Each person has three credit, e.g., FICO® scores, between 300 (worst) to 850 (best). Generally, the higher the credit score, the better the interest rate and loan terms extended to the borrower Therefore, the initial interest rate for a new credit card is indirectly or directly related to the credit score of an individual.

If a consumer increases his or her credit score, banks and other financial institutions may be willing to lend the consumer that money at better interest rates and therefore at better terms. The consumer can increase their credit score by responsibly managing their financial affairs; for example, by paying their monthly balances in full, on time, and not “overextending” themselves with numerous open and active credit accounts.

However, the current credit card issuers do not provide direct or explicit incentives to their customers to assist in or encourage improved credit management and the resulting improvement in credit scores. Accordingly, there is a need to provide credit products with incentives tied to a consumer's credit score and where rewards are provided if specific incentive targets are achieved.

### BRIEF DESCRIPTION OF THE DRAWINGS

FIG. 1 illustrates a credit instrument system or credit card system according to an embodiment of the present invention.

FIG. 2 illustrate a method of modifying a parameter of a consumer credit account according to an embodiment of the invention; and

FIG. 3 illustrates a method of the changing of a secured credit card to an unsecured credit card based on a credit score according to an embodiment of the invention.

### DETAILED DESCRIPTION

The present invention is directed to a system and method for developing a credit instrument, such as a credit card, that rewards consumers or users for improving their credit score, e.g., FICO® score. This system allows consumers to improve their financial situations by lowering interest rates, establishing reward points, paying off credit instrument's balance, changing a secured credit instrument to a non-secured instrument, etc., based on changes in the consumer's credit score.

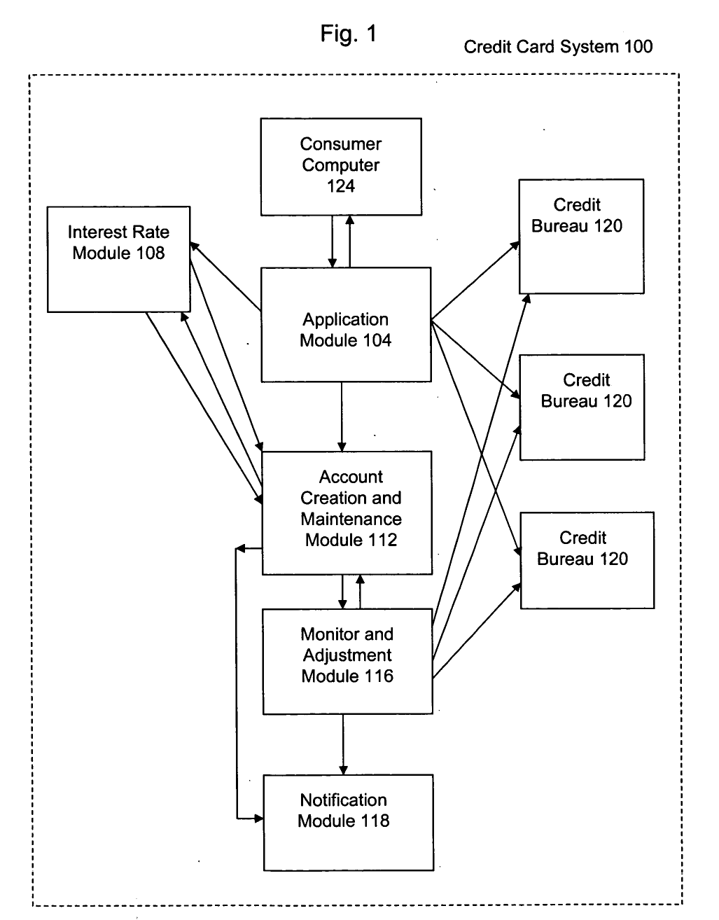

Credit cards, pre-paid credit cards, secured credit cards, debit cards, personal lines of credit, product-financing installment loans, cash advances, are representative, but not limiting, credit or debt instruments. This invention is equally applicable to debt instruments. For simplicity, the discussion of FIGS. 1, 2 and 3 utilizes the term credit card, although the discussion is equally applicable to all of the credit or debt instruments discussed above, and other similar credit or debt instruments.

FIG. 1 illustrates a credit card system according to an embodiment of the present invention. The credit instrument system 100 includes an application module 104, an interest rate calculation module 108, an account creation and maintenance module 112, and a monitor and adjusting module 116. The credit card system 100 may interface with a credit bureau 120. The credit card system 100 also interfaces with a user via an input or automatically with a user or consumer system 124.

In an embodiment of the invention, the application module 104, the interest rate calculation module 108, the account creation and maintenance module 112, the monitor and adjusting module 116, and the notification module 118 may all reside in a single computing device. In other embodiments of the invention, the above-mentioned modules may be divided up between two or more computing devices. In an embodiment of the invention, each of the modules 104, 108, 112, 116, and 118 may reside on multiple computing devices due to the size of the application or because the credit card issuer's system is designed as a distributed computing system architecture.

A credit card applicant or consumer may initiate the process by submitting a credit card application to the application module 104 of the credit card issuer's computer. The application may be submitted electronically via the Internet, via U.S. mail, via Express mail, or over the telephone. As illustrated by FIG. 1, a consumer computing device 124 may electronically transmit the application to the application module 104 of the credit card issuer. The application module 104 determines whether to accept or reject the application of the user. In an embodiment of the invention, the application module 104 may send out requests to multiple credit bureaus 120 or other independent credit reporting agencies, utilizing one or more identifiers of the consumer, e.g., a drivers license, a social security number, an address, or a name. The credit bureau(s) may transmit or send a credit report including a credit score, e.g., a FICO® score, to the issuer computer, which may transmit the credit report and the credit score to the application module 104. The application module 104 may receive the credit report including the credit score, and may interpret and analyze the credit report and the credit score. The application module 104 may determine whether or not to accept the application from the consumer or user.

The term “credit score” is not limited to a classic FICO® (Fair Isaac) score. The invention also can utilize “next generation” credit scores, other Fair Isaac generated scores such as scores that are calculated without the use of credit reports, and “industry specific” credit scores. “Industry specific” credit scores may be credit scores designed specifically for industries such as credit cards, auto lending, mortgage lending, etc. In addition, specialized Fair Isaac scores (e.g., revenue scores and behavior scores) may be utilized by financial institutions. Other example scores which could be utilized in the present invention include the Experian's National Score. Also, financial institutions may create “credit score-like” scores which are based on the financial institution's internal data, which can also be utilized within the invention.

In an embodiment of the invention, the application module 104 may notify the user, consumer, or applicant that the credit card application has been accepted or denied. The application module 104 may notify the user by transmitting instructions that 1) a phone call is to be placed to the applicant/consumer; 2) a letter is to be sent out to the applicant or consumer; or 3) an electronic message, e.g., an email, is to be transmitted to the application or consumer. If the credit card application is denied, the application module 104 updates an internal record. The internal record may include all of the information that the applicant supplied, so as to keep track of the number of times the applicant or individuals with similar personal information attempt to obtain a credit card. The notification includes reasons why the credit card application was denied.

If the application module 104 accepts the credit card application, the application module 104 sends a portion of the applicant personal information, and a portion of the credit report including the credit score to an account creation and maintenance module 112. The account creation and maintenance module 112 opens up an account for the user or consumer. The account includes records of consumer's personal information, the consumer's credit score, and any other credit report information that the issuer decides is relevant to be stored. In an embodiment of the present invention, this consumer account may be stored in a memory in the computing device that where the account creation and maintenance module 112 is installed and operating. In an embodiment of the invention, this consumer ac count may be stored inside a memory in a separate computing device, e.g., one that does not include the account creation and maintenance module 112.

After the consumer's account has been created, the account creation and maintenance module 112 may communicate with an interest rate module 108. The account creation and maintenance module 112 may transmit credit report information including the credit score to the interest rate module 108 in order for the interest rate module 108 to establish an initial interest rate for the consumer's account. In an embodiment of the invention, the application module 104 may transmit the credit reporting information including the credit score to the interest rate module 108. The interest rate module 108 receives the information and establishes the initial interest rate for the consumer's account and transmits this information to the account creation and maintenance module 112. The account creation and maintenance module 112 also determines the credit limit for the consumer account, the billing period for the consumer account, and the terms and conditions of the consumer account. After these items have been determined, the account creation module 112 indicates that the consumer account is activated.

The account creation and maintenance module 112 notifies the user or consumer that the consumer account has been activated. The account creation and maintenance module 112 may communicate this account activation information directly to the user or consumer computer 120. In an embodiment of the invention, the account creation and maintenance module 112 may communicate with a notification module 118, which in turn notifies the consumer. In an embodiment of the invention, the account creation and module 112 may generate or transmit instructions to 1) notify a consumer via a letter that the consumer account has been activated; 2) notify a consumer via a phone call that the consumer's account has been activated; or 3) notify a user via an electronic message, e.g., an email, that an account has been activated, The notification to the consumer may include information regarding 1) the initial interest rate for the consumer account; 2) the terms and conditions of the consumer account; and 3) the credit limit for the consumer account.

Periodically, the credit card system 100 may monitor the consumer's credit score. The period of monitoring may be established in the terms and conditions of the consumer account. In an embodiment of the invention, the monitor and adjustment module 116 may automatically request an updated credit score based on a pre-determined monitoring period. For example, the monitoring period could be every month; every three months, every six months, or every year. In an embodiment of the invention, a monitor and adjustment module 116 may be notified by the account creation and maintenance module 112 that the monitoring period has elapsed. In this embodiment, the monitor and adjustment module 116 may transmit a request (electronically, telephonically, or via mail) to the credit bureau(s) 120 for an updated credit score for the consumer. In response, the credit bureaus 120 may respond with only an updated credit score or may respond with the updated credit score and an updated credit report.

The monitor and adjustment module 116 may receive the updated credit score and other information from the credit bureau(s) 120. The monitor and adjustment module 116 may compare the updated credit score to the originally stored credit score. If there is a difference between the updated credit score and the originally stored credit score, the monitor and adjustment module 116 may adjust a parameter of the consumer credit card account based on the change in the consumer's credit score.

The monitoring and adjustment module 116 performs the monitoring of the consumer credit card account on a routine basis. The credit card issuer and the consumer can agree to a specific monitoring period, e.g., every 3 to 6 months, where the credit score is automatically updated.

In an embodiment of the invention, the monitor and adjustment module 116 may adjust the interest rate of the consumer credit card account. For example, if the credit score has increased, meaning that the consumer has a better credit rating, then the monitor and adjustment module 116 may communicate with the interest rate module 108 to determine an updated, lower interest rate. Conversely, if the credit score has decreased, then the monitor and adjustment module 116 may communicate with the interest rate module 108 to determine an updated, higher interest rate. The credit score increases or decreases may be required to be sustained over a pre-determined number of months before the monitor and adjustment module 116 communicates changes with the interest rate module 108. In this fashion, the consumer is rewarded and encouraged to keep improving his or her credit score and sustaining those improvements. Because the interest rate is decreased, the monthly finance charges would be reduced for any consumer carrying an unpaid balance from month-to-month. In an embodiment of the invention, the monitor and adjustment module 116 may actually store credit scores thresholds and corresponding interest rate increases or decreases. For example, for every 10 point increase or decrease in a credit score, the interest rate may increase by 0.5%, correspondingly. Thus, a 30 point increase in credit score may result in a 1.5% reduction in credit card interest rate.

In an embodiment of the invention, the monitor and adjustment module 116 may pay off a specific dollar amount of the consumer's account balance if a specified credit score reduction is achieved in a certain time period. Illustratively, the monitor and adjustment module 116 may identify that a 20 point credit score increase was achieved in the last six months. In response, the monitor and adjustment module 116 may pay off a predetermined dollar amount of the consumer credit card account. In this illustration, the monitor and adjustment module 116 may instruct the account creation and maintenance module 112 to decrease the consumer account outstanding balance by $80.00. In a similar fashion, the monitor and adjustment module 116 may instruct the account creation and maintenance module to decrease the consumer account outstanding balance by a certain percentage. For example, if a 20 point credit score increase was achieved, the monitor and adjustment module 116 may instruct the account creation and maintenance module 112 to reduce the consumer account balance by 1%. Under either scenario, the monitor and adjustment module 116 may notify the consumer of the reduction or either the predetermined dollar amount or the predetermined percentage of the consumer's account balance. The monitor and adjustment module 116 may utilize the notification module 118 to notify the consumer.

In an embodiment of the invention, the monitor and adjustment module 116 may generate reward points if an increase in the credit score for a predetermined time period is achieved by the consumer. For example, if the consumer's credit score increased 25 points in a three-month timeframe, the monitor and adjustment module 116 may generate 2000 points as a reward for increasing the consumer's creditworthiness. The 2000 point-may be added to the other reward points that may exist in the consumer account records of the account creation and maintenance module 116. The monitor and adjustment module 116 may utilize the notification module to notify the consumer of the reward points or the new reward points may be listed on the consumer's next credit card statement.

In an embodiment of the invention where the credit card is a secured credit card, the monitor and adjustment module 116 may identify that a certain credit score improvement has been achieved by the consumer. If the specified credit score improvement has been achieved, the monitor and adjustment module 116 may change the terms and conditions of the consumer credit card account so that the consumer credit card account becomes an unsecured credit card, i.e., the status is changed from secured to unsecured. Illustratively, a secured credit card may utilize collateral of the consumer, i.e., personal property or real property, to back up the money lent to the consumer. The collateral may be a cash balance maintained in an account with the bank or financial institution extending the credit to the consumer, or an ownership document for some of the consumer's property, e.g., a deed of trust that the consumer has execute. If the consumer achieves a 50 point increase in a credit score in a six-month timeframe, the monitor and adjustment module 116 may instruct an individual working for the credit card issuer to return the ownership document (and thus the claim to ownership in the property) and to remove any assignment or other ownership claims that the credit card issuer may have recorded with a government agency. In addition, the monitor and adjustment module 116 instructs the account creation and maintenance module 112 to change the status of the consumer account from a secured credit card account to an unsecured credit card account. In an embodiment of the invention, the monitor and adjustment module 116 may utilize the notification module 118 to notify the consumer of the change in credit card status.

The monitor and adjustment module 116 also may penalize consumers or customers that do not pay his or her credit card accounts on time. For most credit card products, if you are late with a payment, 1) the interest rate may rise and/or 2) a penalty charge of a specific amount will be charged to your credit card. In addition, most credit card issuers inform credit reporting agencies that a late payment has been made, which then damages the consumer's credit score. In contrast, the credit card product of the present invention, takes away the privilege of using the credit card product for a specified period of time if a consumer or customer has paid late or has exceeded the credit limit for the credit card product. There is no reporting of the lateness to credit bureaus, (and thus no harm to the consumer's credit score). Instead, the credit card account is frozen and cannot be utilized. For example, if a consumer is late on one payment, then the credit card account may be frozen for a month and if the consumer is late on two payments in six months, then the credit card account may be frozen for three months. In other words, the penalties may grow exponentially. Additionally, if the consumer charges over the credit limit on the credit card product, the credit card account may be frozen or unusable for two weeks. The credit card issuer can determine and set appropriate penalties or disincentives for paying late and exceeding the credit limit according to their unique business needs.

The credit card issuer does not report the late payment to the credit reporting agencies for the first late payment as long as the consumer or customer makes the payment on the credit card account within an established timeframe. Illustratively, the credit card issuer notifies the consumer of the lack of payment, i.e., the late payment, and establishes a timeframe after the consumer or customer is notified in which the account has to be paid. If the consumer does not make the payment on the credit card account within the timeframe established by the credit card issuer, then the credit card issuer sends a late payment notification to the credit reporting agencies. In an embodiment of the invention, this notification and monitoring of the payment is performed automatically, along with the generation of the report to the credit reporting agencies. Illustratively, this timeframe could be one week, two weeks, or three weeks.

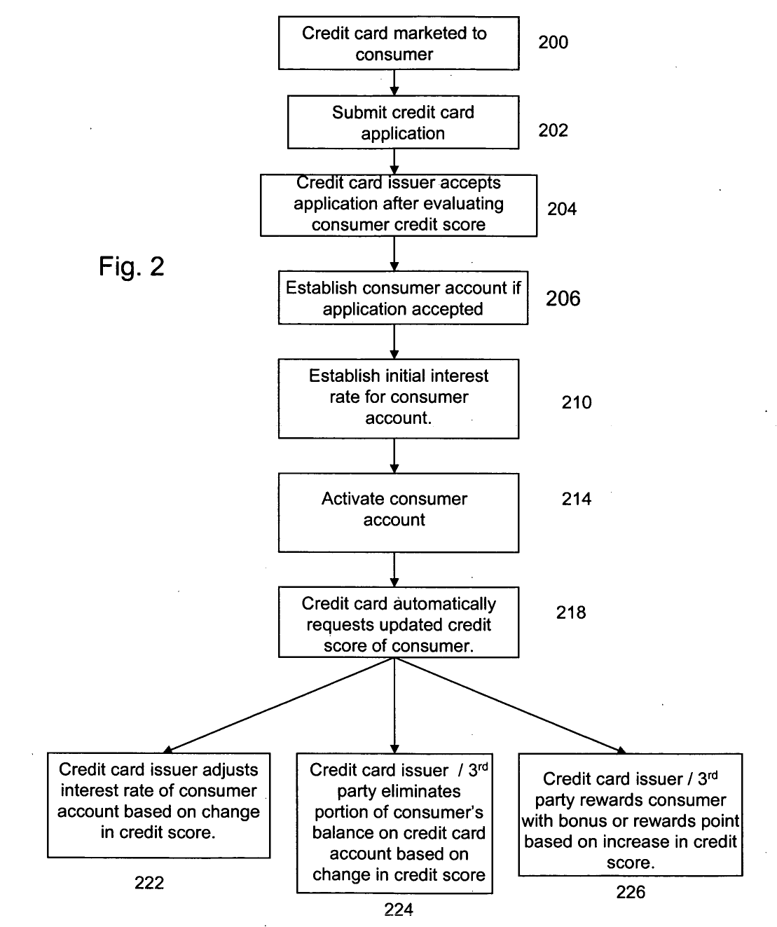

FIG. 2 illustrates a method of modifying a parameter of a consumer credit account according to an embodiment of the invention. A credit card issuer may decide to offer or market 200 a credit card product to a specific portion of the consumer base. For example, the credit card issuer may decide to target a group of consumers having a credit score range between 640-700, and who have had an increase in income in the last three months. The credit card issuer may generate a list of the consumers who meet these qualifications from public or private databases and send out their credit card applications to these consumers. The information may be sent out to the consumers via facsimile, email, junk mail, U.S. mail, etc. A targeted consumer or applicant may receive the offer for the credit card product. The offer would include the details of the terms and interest rates available to the targeted consumers. For example, the offer would highlight 1) that credit scores would be monitored on a periodic basis, e.g., monthly or every two months, and the decreases in interest rates (or awarding of rewards) that are possible if improvements in the credit score are achieved and then maintained. In other words, the offer would highlight the terms of the credit card product. The consumer, customer, or user would be enticed to apply for this type of credit product because it provides a benefit (e.g., lower interest rates or more reward points) if the consumer is responsibly monitoring his or her own financial affairs.

The consumer or applicant may submit 202 a credit card application to a credit card issuer. The credit card issuer may be, for example, a bank, a financial advisor, a credit union, or a life insurance company. The credit card issuer may analyze the credit card application and determine whether or not the applicant or consumer is qualified to receive the issuer's credit card. The credit card issuer may receive information from a credit bureau or multiple credit bureaus. The credit card issuer may analyze the income of the applicant, the credit history of the applicant; the employment history of the applicant, etc. in order to determine if the applicant or consumer is qualified to receive the issuer's credit card. If the applicant or consumer is qualified, the credit card issuer accepts 204 the application for the issuer's credit card.

The credit card issuer establishes 206 an account for the applicant or consumer if the credit card application is accepted. The account may be referred to as consumer account. The consumer account may include information from the credit bureaus. The consumer account may also include information that the consumer submitted on the credit card application. The consumer account includes the credit score received from the third party or credit bureau. The initial credit score is stored in a computing system run or operated by or on behalf of the credit card issuer. The credit card issuer may also determine a credit limit for the consumer, a billing cycle for the consumer, and terms and conditions for the consumer's credit card account. The credit card issuer may utilize the information received from the credit bureau and/or the applicant to establish 210 an initial interest rate. In an embodiment of the invention, the initial interest rate may be based on the credit score. After the initial interest rate, the credit limit, the billing cycle, and the terms and conditions are established for the consumer account, the consumer account may be activated 214. The consumer may be notified by the credit card issuer of the initial interest rate, the credit limit, the billing cycle, and the terms and conditions. The consumer may begin to utilize the credit card.

The credit card issuer may establish an automatic monitoring period in the terms and conditions of the credit card. Alternatively, an applicant or consumer may request that a specific automatic monitoring period is established by the credit card issuer reevaluate the creditworthiness of the consumer. After expiration or lapsing of the monitoring period, e.g., three months has elapsed, the credit card issuer may monitor 218 the credit score of the consumer. The credit card issuer may request this information from an independent third-party or from multiple credit card bureaus. The credit card issuer may average credit scores from the multiple sources. In an embodiment of the invention, the credit card issuer may modify the credit scores received from the independent third party or credit bureaus to compensate for the requesting of the credit score. Account management inquiries, such as the automatic monitoring requests generated by the credit card issuer, do not adversely affect the credit score.

After receiving the credit score, the credit card issuer may compare the received credit score, e.g., the updated credit score, to the stored initial credit score. The difference in the received credit score and the updated credit score is calculated and an increase or decrease is noted. In an embodiment of the invention, the credit card issuer may adjust 222 the interest rate of consumer based on a change of the credit score over a sustained period of time. If the credit score has not changed, or if the change in credit score is not significant, in this embodiment of the invention, the interest rate of the consumer for the consumer account remains the same. For example, the credit card issuer may establish that if the credit score has increased or decreased by more than or less than five points, then the interest rate of the consumer remains the same.

Illustratively, if the credit score has increased, representing that the creditworthiness of the consumer has improved, the credit card issuer may lower the interest rate of the credit card for the consumer's account. Conversely, the credit card issuer may increase the interest rate for the consumer's account if the credit score has decreased. The credit card issuer may establish a rate table that ties specific increases or decreases in credit scores to specific reductions or increases in interest rates. For example, the table below illustrates such a rate table.

| Credit Score Difference | |
|---|---|
| (+- Increase/- Decrease) | Interest Rate Increase or Decease |
| 15 Point Increase | −0.5 Decrease |
| 40 Point Increase | −1.0 Decrease |
| 20 Point Decrease | +0.2 Increase |
| 40 Point Decrease | +0.5 Increase |

In an embodiment of the invention, the credit issuer may pay off or eliminate or erase 224 a portion of the credit card consumer's account balance based on a reduction of the credit score. If a reduction of the credit score is achieved by the consumer, then the credit card issuer may pay off or forgive a specific amount of the consumer's credit card account balance. For example, if a 10 point increase in the credit score is achieved, the credit card issuer may pay off $100 of the consumer's credit card account balance. In an embodiment of the invention, if a reduction of the credit score is achieved by the consumer, then the credit card issuer may pay off/eliminate/or erase a specific predetermined percentage of the consumer's credit card account balance. For example, if a 20 point increase in the credit score is achieved by the consumer, the credit card issuer may reduce or eliminate 1.5% of the consumer's credit card balance.

Instead of or in partnership with the credit card issuer, a third-party may pay off a specific amount of the customer's credit card account balance. For example, Ameritrade may establish a relationship with a financial institution where Ameritrade will pay off a specific amount or specific percentage of the consumer's credit card account balance in exchange for obtaining access to the credit card issuer's customers. Other potential third parties could include financial internet sites such as LendingTree or car companies such as Toyota, General Motors, Ford, Nissan, and Chrysler. Illustratively, the third party may be allowed to place advertisements on credit card statements, include mailers in credit card statements, or to have its advertisements played when the customer or consumer is on a telephone waiting to talk to the credit card issuer's representative.

In an embodiment of the invention, the credit card issuer may reward the credit card holder or consumer by establishing 226 reward or bonus points for any reductions of the credit score. In this embodiment of the invention, if the credit score is achieved by the consumer, then the credit card issuer may generate a specific amount of reward points and place these reward points in the consumer's account in the credit card issuer computer system. These reward or bonus points may be added to existing bonus or reward points that are awarded to the consumer based on the dollar amount of purchases made on the credit card. Illustratively, if the consumer has increased his or her credit score by 15 points, the issuer may generate 2000 reward points and place the 2000 reward or bonus points in the consumer's credit card account.

In addition, a third party and the credit card issuer may establish a relationship or partnership so that the third party rewards the consumer or customer with reward points for achieved decreases in credit scores. Again, the third party may provide this reward in exchange for the opportunity to have their products placed in mailers or statements sent to the consumer or customer. In an embodiment of the invention, the credit card issuer could also sell its customer list to the third party in exchange for providing the credit card issuer's customers with reward points when credit scores are decreased.

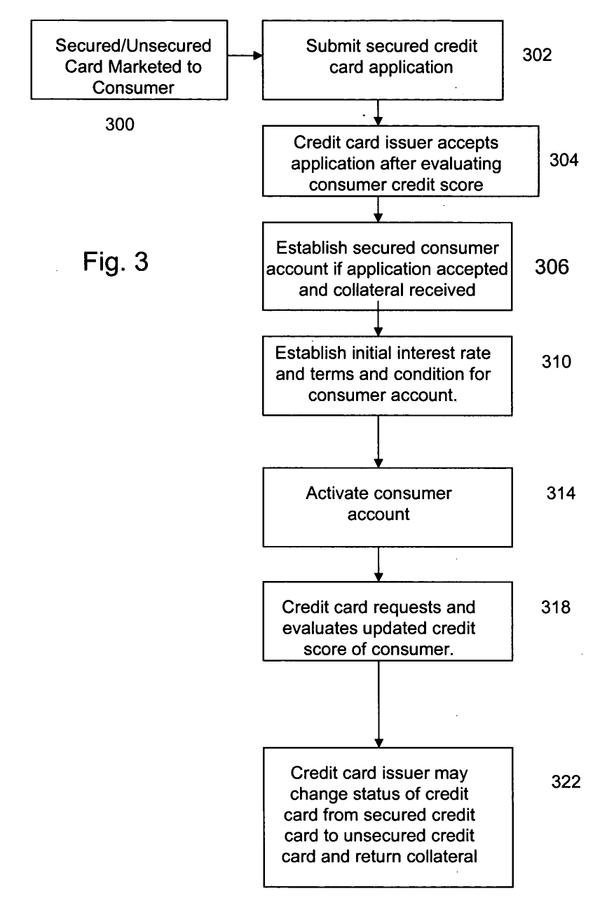

FIG. 3 illustrates a method of the changing of a secured credit card to an unsecured credit card based on a credit score according to an embodiment of the invention. A credit card issuer may market 300 its credit card product to a select group of consumers. In this embodiment, the consumers or customers may be individuals who require some type of collateral in order to receive credit from a credit issuer. Illustratively, these consumers could be students, individuals exiting bankruptcy, individuals who have gone through a divorce, or who recently suffered a job loss. In the application sent to the consumer, the credit card issuer would highlight that the terms and conditions of the credit card would automatically change from secured to unsecured if the consumer or customer proved they were improving the management of their financial affairs. The consumer or applicant would received the credit card application and be enticed to apply because other credit card products would most likely require some sort of collateral and would not be able to be changed into an unsecured credit card.

A consumer or applicant may submit 302 a credit card application for a secured credit card to a credit card issuer. The credit card issuer may be a bank, a financial advisor, a credit union, or a life insurance company. The credit card issuer may analyze the credit card application and determine whether or not the applicant or consumer is qualified to receive the issuer's secured credit card. The credit card issuer may receive information from a credit bureau or multiple credit bureaus. The credit card issuer may analyze the income of the applicant, the credit history of the applicant; the employment history of he applicant, etc. in order to determine if the applicant or consumer is qualified to receive the issuer's credit card. In addition, the credit card issuer may determine what type of collateral is required to secure the credit card or credit instrument. For example, the collateral may include the assignment of personal or real property of the consumer to the credit card issuer. Illustratively, the consumer may assign to or execute a deed of trust from the credit instrument issuer which transfers the ownership of the real property to the credit instrument issuer until monies lent by the credit card or credit instrument issuer are paid off by the consumer. If the applicant or consumer is qualified, the credit card issuer accepts 304 the application for the credit instrument or credit card.

The credit card issuer establishes 306 an account for the applicant or consumer if the credit card application is accepted. The account may be referred to as consumer account. As part of the establishing of the secured consumer account, the credit card issuer may require, under certain operating conditions, the receipt of the collateral or the ownership document securing the credit card before the account may be activated. The consumer account may include information from the credit bureaus. The consumer account may also include information that the consumer submitted on the credit card application. The consumer account includes the credit score received from the third party or credit bureau. The initial credit score is stored in a computing system run by the credit card issuer. The credit card issuer may also determine a credit limit for the consumer, a billing cycle for the consumer, and terms and conditions for the credit card account. The credit card issuer may also request that the consumer assign the interest in collateral to the credit card issuer. In an embodiment of the invention, the credit card issuer may also request that the consumer execute a deed of trust prepared by the credit card issuer for the collateral. In an embodiment of the invention, the consumer sends 308 or electronic transmits the ownership document or assignment to the credit card issuer.

The credit card issuer may utilize the information received from the credit bureau and/or the applicant to establish 310 an initial interest rate. In an embodiment of the invention, the initial interest rate may be based solely on the credit score or may be based on a combination of factors and parameters, which include the credit score. After the initial interest rate, the credit limit, the billing cycle, and the terms and conditions are established for the consumer account, the consumer account may be activated 314. In this embodiment of the invention, the terms and conditions may outline information such as foreclosure procedures on the secured collateral property in case the credit card consumer defaults on the credit card. In addition, the terms and conditions may outline the conditions that may allow the consumer to move from a secured credit instrument to an unsecured credit instrument. The consumer may be notified by the credit card issuer of the initial interest rate, the credit limit, the billing cycle, and the terms and conditions. The consumer may begin utilizing the credit card.

The credit card issuer may establish an automatic monitoring period in the terms and conditions of the credit card. In this embodiment of the invention, the applicant or consumer may wish to make the secured credit card an unsecured credit card, i.e., meaning that no collateral would be needed for the credit card. In most cases, the credit card issuer would not change the status from a secured credit card to an unsecured credit card unless a significant increase in credit score was achieved by the consumer. After a pre-determined or pre-established monitoring period, e.g., at least nine months has elapsed, the credit card issuer may monitor or reevaluate 318 the credit score of the consumer. The credit card issuer may request this information from an independent third-party or from multiple credit card bureaus. In an embodiment of the invention, the credit card issuer may average credit scores from the multiple sources.

After receiving the credit score, the credit card issuer may compare the received credit score, e.g., the updated credit score, to the stored initial credit score. The difference in the received credit score and the updated credit score is calculated and an increase or decrease is noted. In an embodiment of the invention, the credit card issuer may decide 322 to change the status of the consumer's credit card account, and hence the credit card, from a secured credit card to an unsecured credit card. Illustratively, if after nine months, the consumer's credit score has increased by 75 points, the credit card issuer may decide that collateral is no longer required to secure the credit card account, and may remove this condition from the consumer accounts terms and conditions. If the credit score has not changed, or if the change in credit score has decreased, then the consumer credit card account may maintain its secured status. In this embodiment of the invention, the credit card issuer may also return the collateral or ownership document to the consumer.

In an embodiment of the invention, the credit card issuer may request the consumer maintain an increased credit score for a specific period of time. For example, the credit card issuer may require that the consumer increase his or her credit score by 75 points and also that the consumer maintain this increased credit score for at least four months. This protects the consumer from being able to benefit from a one-time large increase in their credit score, when the credit score subsequently decreases in a short timeframe. The credit card issuer may note that the consumer has reached the necessary increase in credit score, e.g., 50, 75, or 100 point increase, during a certain time period and then the credit card issuer may re-check and re-evaluate the credit score again in a specified timeframe, e.g., 4, 6, or 8 months, to make sure the increase in credit score has been maintained.

The embodiments described above may be combined together by the issuer of a credit instrument, e.g., a credit card. For example, the credit card issuer could both pay off a certain percentage of the consumer account balance and provide the consumer with reward points if a predetermined credit score threshold had been achieved. In addition, the issuer may include two different thresholds in reduction of credit scores which need to be met in order receive the benefits of the credit score reduction. Illustratively, if the consumer increases its credit by 75 points, then a secured credit instrument may be converted into an unsecured credit instrument and if the consumer increases its credit score by an additional 25 points, then the interest rate on the unsecured credit instrument may be lowered by 0.25%.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A method of determining an interest rate for a credit card issued by a credit card issuer, comprising:
receiving an application for the credit card;
accepting, by the credit card issuer, the application for the credit card;
establishing a consumer account and an initial interest rate based on an initial credit score for a consumer and other consumer credit information;
activating the consumer account;
automatically monitoring a credit score of the consumer on a periodic basis; and
adjusting the initial interest rate to a new interest rate if the credit score of the consumer has changed.

2. The method of claim 1, wherein the new interest rate is lower than the initial interest rate if the credit score has increased.

3. The method of claim 1, wherein the credit card issuer accepting the application for the credit card includes contacting an independent third party to receive credit information regarding the consumer and the credit information includes the credit score.

4. A method of rewarding a consumer for increasing a credit score, comprising:
receiving an application for a credit card;
accepting, by a credit card issuer, the application for the credit card;
establishing a consumer account and an initial interest rate based on an initial credit score and other consumer credit information;
activating the consumer account,
automatically monitoring a credit score of the consumer on a periodic basis; and
paying down an account balance of the consumer account by a predetermined amount if the credit score has increased by a pre-determined amount.

5. The method of claim 4, wherein the credit card issuer accepting the application for the credit instrument includes contacting an independent third party to receive credit information regarding the consumer and the credit information including the credit score.

6. The method of claim 4, further including lowering the initial interest rate of the credit card to a new interest rate if the credit score of the consumer has increased.

7. A method of rewarding a consumer for increasing a credit score, comprising:
receiving an application for a credit instrument;
accepting the application, by the credit instrument issuer, for the credit instrument;
establishing a consumer account and an initial interest rate based for the credit instrument based on an initial credit score and other consumer credit information;
activating the consumer account;
automatically monitoring the credit score of the user on a periodic basis; and
paying off an established percentage of a consumer's outstanding balance on the consumer account if a specified credit score point increase is achieved.

8. The method of claim 7, further including lowering the initial interest rate of the instrument to a new interest rate if the specified credit score point increase is achieved.

9. The method of claim 7, wherein the credit instrument issuer accepting the application for the credit instrument includes contacting an independent third party to receive credit information regarding the consumer and the credit information including the credit score.

10. A method of rewarding a consumer for increasing a credit score, comprising:
receiving an application for a credit card;
accepting the application for the credit card, by the credit card issuer;
establishing a consumer account and an initial interest rate based on an initial credit score and other consumer credit information, the consumer account including tracking of reward points related to charges made utilizing the credit card;
activating the consumer account;
monitoring the credit score of the consumer on a periodic basis; and
providing a certain amount of reward points to the consumer to be added to existing reward points in the consumer account if the credit score of the consumer has increased by a predetermined amount.

11. The method of claim 10, further including paying off a portion of an account balance of the consumer account if the credit score of the consumer has increased by a second predetermined amount.

12. The method of claim 10, further including paying off a percentage of an account balance of the consumer if the credit score of the consumer has increased by a second predetermined amount.

13. The method of claim 10, further including reducing the initial interest rate for the consumer account to a lower interest rate if the credit score of the consumer has increased by a second predetermined amount.

14. A method, comprising:
receiving an application for a secured credit card;
accepting the application, by the credit card issuer, for the secured credit card;
establishing a consumer account and an initial interest rate for the secured credit card based on an initial credit score and other consumer credit information;
activating the consumer account;
automatically monitoring a credit score of the consumer on a periodic basis; and
converting the secured credit card to an unsecured credit card if the credit score has been increase by a predetermined threshold.

15. The method of claim 14, further including the credit card issuer receiving collateral from the consumer before activating the consumer account for the secured credit card.

16. The method of claim 15, further including the credit card issuer returning the collateral to the consumer if the secured credit card has been converted into the unsecured credit card.

17. The method of claim 14, further including paying off a portion of an account balance of the consumer account if the credit score of the consumer has increased by a second predetermined threshold.

18. The method of claim 14, further including paying off a percentage of an account balance of the consumer if the credit score of the consumer has increased by a second predetermined threshold.

19. The method of claim 14, wherein the converting of the secured credit card to an unsecured credit card, if the credit score has been increased by a predetermined threshold, occurs if the increase in the credit score is maintained for a specified time period.

20. The method of claim 14, further including reducing the initial interest rate for the consumer account to a lower interest rate if the credit score of the consumer has increased by a second predetermined threshold.

21. A method of determining an interest rate for a credit card issued by a credit card issuer, comprising:
marketing a credit card with incentives for improving a credit score to targeted consumers;
receiving an application for the credit card by one of the plurality of targeted consumers and submitting a completed application to the credit card issuer;
accepting, by the credit card issuer, the application for the credit card;
establishing a consumer account and an initial interest rate based on an initial FICO score for a consumer and other consumer credit information;
activating the consumer account;
automatically monitoring the credit score of the consumer on a periodic basis; and
adjusting the initial interest rate to a new interest rate if the credit score of the consumer has changed.

22. The method of claim 21, wherein the new interest rate is lower than the initial interest rate if the credit score has increased.

23. The method of claim 21, wherein the credit card issuer accepting the application for the credit card includes contacting an independent third party to receive credit information regarding the consumer and the credit information includes the credit score.

24. The method of claim 7, wherein a third party pays off the percentage of the consumer's credit card account balance in exchange for the credit card issuer allowing access to the credit car issuer's customers.

25. The method of claim 10, wherein a third party provides the reward points to the consumer in exchange for the credit card issuer allowing access to the credit card issuer's customers.

26. The method of claim 1, further including,
a consumer paying late an amount of the consumer account; and
deactivating the consumer account for a specified period of time in response to the consumer paying late.

27. The method of claim 1, further including,
a consumer exceeding a credit limit on the consumer account; and
deactivating the consumer account for a specified period of time in response to the consumer exceeding the credit limit.
